(19) United States
(12) Patent Application Publication
(10) Pub. No.: US 2020/0016907 A1
(43) Pub. Date: Jan. 16, 2020

(54) IMAGE FORMING APPARATUS

(71) Applicant: KONICA MINOLTA, INC., Tokyo (JP)

(72) Inventor: Takehiro Ogushi, Tokyo (JP)

(73) Assignee: KONICA MINOLTA, INC., Tokyo (JP)

(21) Appl. No.: 16/507,602

(22) Filed: Jul. 10, 2019

(30) Foreign Application Priority Data
Jul. 11, 2018 (JP) 2018-131285

(51) Int. Cl. B41J 11/00; G06K 15/02; G06K 15/12

(52) U.S. Cl. CPC B41J 11/009; G06K 15/129; G06K 15/021

(57) ABSTRACT

An image forming apparatus including: a measurer which measures a physical property of a medium on which an image is formed; an image forming operator which forms the image on the medium; a reader which reads the formed image; and a hardware processor which specifics a medium type based on a measurement result by the measurer and a reading result by the reader.

### BACKGROUND

### Technological Field

The present invention relates to an image forming apparatus.

### Description of the Related Art

There has been conventionally an image forming apparatus winch forms images by applying color materials to recording media. Toners and inks are broadly used as the color materials. The recording media include paper media. The paper media include paper media having various types of thickness of paper, smoothness of medium surface, and basis weights, such as plain paper and high-quality paper. A medium is selected to be used as needed according to the usage of the formed images.

When an image is formed on such various types of media, the image is optimized by adjusting various parameters such as the amount of color material according to the medium type. When the adjustment of the parameters is manually performed by an operator of the image forming apparatus, there is a problem that the work requires trouble, and the amount of medium to be used increases since image formation needs to be performed repeatedly until the image is optimized. On the other hand, when a medium sensor is used to obtain the physical properly so as to completely specify the medium type, there is a problem that various physical properties need lo be measured and the size of medium sensor increases or the cost increases.

With respect to the problems, there is disclosed a technique of reducing user's trouble while avoiding the wrong setting of medium by including a simple medium sensor to narrow down the type of sheets and combining the narrowing result with the setting by the user (for example, Japanese Patent Application Laid Open Publication No. 2005-62915).

However, the conventional techniques still have a problem of requiring user's time and trouble.

### SUMMARY

An object of the present invention is to provide an image forming apparatus which can perform medium setting for image formation more efficiently.

To achieve at least one of the abovementioned objects, according to an aspect of the present invention, an image forming apparatus reflecting one aspect of the present invention includes: a measurer which measures a physical property of a medium on which an image is formed; an image forming operator which forms the image on the medium; a reader which reads the formed image; and a hardware processor which specifies a medium type based on a measurement result by the measurer and a reading result by the reader.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a view for explaining the entire configuration of an image forming apparatus in an embodiment;

FIG. 2 is a block diagram showing the functional configuration of the image forming apparatus;

FIG. 3 is a view showing an example of a test image which is used at the time of specifying the medium;

FIG. 4 is a flowchart showing the control procedure of recording setting processing;

FIG. 5 is a flowchart showing a control procedure of medium measurement processing which is invoked in the recording setting processing;

FIG. 6 is a flowchart showing a control procedure of medium type specification processing which is invoked in the recording setting processing; and

FIG. 7 is a flowchart showing a control procedure of image forming control processing for normal image formation.

### DETAILED DESCRIPTION OF THE EMBODIMENTS

Hereinafter, one or more embodiments of the present invention will be described with reference to the drawings. However, the scope of the invention is not limited to the disclosed embodiments.

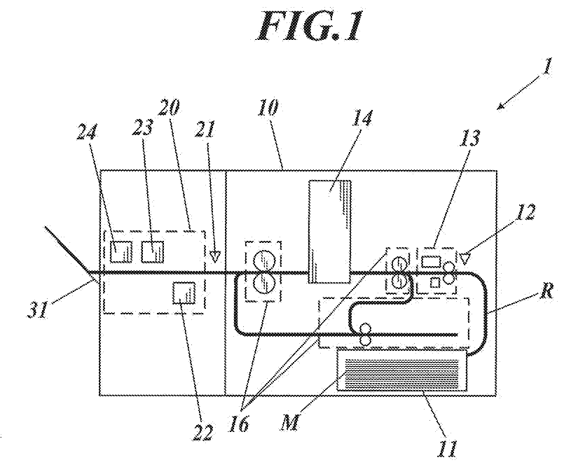

FIG. 1 is a view for explaining the entire configuration of an image forming apparatus 1 in the embodiment.

The image forming apparatus 1 includes a recorder 10, a reader 20, an ejection tray 31, and the like.

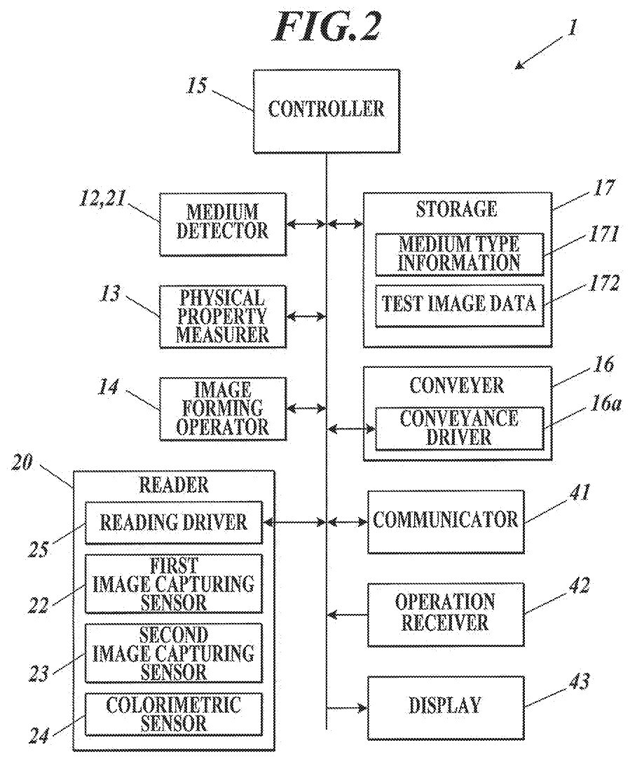

The recorder 10 includes a medium supplier 11, a medium detector 12, a physical property measurer 13 (measurer), an image forming operator 14, a controller 15 (see FIG. 2), a conveyer 16, and the like.

The medium supplier 11 contains a recording medium (medium M) which is the target of image formation by having a tray or the like, and sends out the medium M to a conveyance route R at an appropriate timing according to the control of the controller 15. The conveyer 16 moves the medium M along the conveyance route R at a set speed. The conveyer 16 has rollers which nip and forward the medium M, a rotation motor which rotates the rollers, and the like. The conveyer 16 also has a reversing unit for reversing the from and back sides of the medium M which has an image formed on one surface and performing image formation again. The number and arrangement of the rollers are not limited to those shown in FIG. 1.

The medium detector 12 detects, at a predetermined position, the medium M which is moved on the conveyance route R by the conveyer 16, the predetermined position in the embodiment being a position located before the image forming position of the image forming operator 54 by a predetermined distance. As the medium detector 12, there is used a photo sensor or the like which detects the presence/absence of the medium M by the medium M interfering with light, or detects the arrival of medium M at the predetermined position according to the change in detected intensity of reflected light caused by the presence/absence of medium M, for example. On the basis of the timing when the head of the medium M was detected by the medium detector 12 and the conveyance speed by the conveyer 16, the image formation timing by the image forming operator 14 is controlled and art image is formed at an appropriate position on the medium M.

The physical property measurer 13 measures the physical property of the medium M. The physical property of the measurement target includes thickness, basis weight, smoothness of the surface and the like, though not especially limited. Though the measurement method is not especially limited, the thickness is measured by a displacement roller which detects the interval between the axes of two rollers that can move in the thickness direction according to the thickness of the medium M, for example. The smoothness is calculated on the basis the intensity ratio by using a reflection sensor which outputs intensities and/or intensity ratio between regular reflected light and scattered reflected light of the emitted light. The basis weight is calculated on the basis of the transmitted light amount through the medium M of the emitted light, the above-mentioned thickness, and the like. The basis weight may be calculated by using the result of a weight sensor which measures the weight of the medium M directly.

These measuring operations by the physical property measurer 13 are performed at a plurality of points in the medium M while temporarily stopping the movement of the medium M by a predetermined distance. The result of arithmetic processing such as the average of the obtained plurality of values is finally used as a physical property value.

The image forming operator 14 has a print engine which forms an image on the medium M by attaching and fixing a color material such as a toner and an ink on the medium M. Though not especially limited, the image forming operator 14 in the embodiment forms (develops) toner images of four colors of C, Y and K on a photoreceptor by an electrophotographic method, and forms, on the medium M, an image which is a color image transferred via a transferring member in the embodiment.

The reader 20 reads the surfaces (front and back sides) of the medium M which is moved on the conveyance route R after the medium M passes the image forming position by the image forming operator 14. That is, the reader 20 can read a part of or the entire formed image. The reader 20 includes a medium detector 21, a first image capturing sensor 22, a second image capturing sensor 23, a calorimetric sensor 24, and the like.

The medium detector 21 detects the medium M at a predetermined position in the reader 20, which position located before the reading range of the first image capturing sensor 22 by a predetermined distance in the embodiment. The medium detector 21 may have a same configuration as that of the medium detector 12.

The first image capturing sensor 22 and the second image capturing sensor 23 optically capture the medium M. The that image capturing sensor 22 captures the back-side surface of the medium M, and the second image capturing sensor 23 captures the front-side surface of the medium M. That is, the reader 20 can capture (read) both sides by a single movement of the medium without reversing the medium M. As the first image capturing sensor 22 and the second image capturing sensor 23, a line sensor or the like using CMOS image capturing elements is used, for example. A part of (for example, only the second image capturing sensor 23) or all of the sensors can be used not only for after-mentioned recording setting processing, but also for adjustment of positional misalignment at the time of normal (usual) image forming operation, feedback adjustment to the temporal change of the color, detection of abnormalities of the formed image, and the like. In the embodiment, the arrangement is made such that the image capturing of the back-side surface by the first image capturing sensor 22 is performed earlier than the second image capturing sensor 23. However, the present invention is not limited to this.

The colorimetric sensor 24 measures spectrum by dividing the reflected light on the surface of the medium M, and calculates and outputs color values in a predetermined color system such as chromaticity, saturation and hue. As the color system, an appropriate system such as L*a*b* color system or XYZ color system is used, and the color system may be switchable.

The medium M which was sent from the medium supplier 11 and passed through the recorder 10 and the reader 20 is ejected to the ejection tray 31. A post-processing device or the like which performs various types of post-processing such as trimming and/or sorting may be connected before the ejection tray 31.

FIG. 2 is a block diagram showing the functional configuration of the image forming apparatus 1 in the embodiment.

The image forming apparatus 1 includes a controller 15 (medium specifier, operation controller), a conveyance driver 16a, a storage 17, a communicator 41, an operation receiver 42, a display 43, and the like in addition to the above-mentioned medium detectors 12, 21, the physical property measurer 13, the image forming operator 14, and the reader 20.

The controller 15 integrally controls the various operations of the image forming apparatus 1. The controller 15 is a hardware processor which includes a CPU (Central Processing Unit) and a RAM (Random Access Memory). The controller 15 performs operation control of forming an image (including a test image to be described later) with the image forming operator 14 by reading out the control program stored in the storage 17 and executing the program with the CPU. The controller 15 specifics the type of the medium M which is set in the medium supplier 11 by the after-mentioned recording setting processing, and performs setting regarding the image forming operation on the basis of the specification result.

The conveyance driver 16a outputs a drive signal of causing the rotation operation of motor of the conveyer 16 and the supplying operation of the medium supplier 11 on the basis of the control by the controller 15, and adjusts whether to perform the conveyance operation of the medium M and the conveyance speed.

The storage 17 stores programs executed by the controller 15, setting data which is referred to when the program is executed, and the like. The storage 17 has a nonvolatile memory and/or an HDD (Hard Disk Drive), and the like. The storage 17 also stores image data of the target to be formed which was obtained from outside via the communicator 41, the processing data of the image data, medium type information 171 including the physical property information and property information at the time of image formation for each type of various media which can be the image formation target, test image data 172 for calibration and/or operation setting, and the like.

The reader 20 includes a reading driver 25. The reading driver 25 causes the above-mentioned various sensors included in the reader 20 to perform operations on the basis of the control by the controller 15. The reading driver 25 causes the sensors to perform image capturing and colorimetry of the image formed on the medium M at a timing which is determined according to the position of the medium M, the conveyance speed, and the like.

The communicator 41 performs control of communication which is performed with an external communication device on the basis of a predetermined communication standard. As the communication standard, communication by LAN (Local Area Network) is used, for example, and the communicator 41 includes a network card for performing communication control by LAN, and the like.

The operation receiver 42 receives the input operation from outside such as the user, and outputs the received contents as an input signal to the controller 15. The operation receiver 42 has, for example, a touch panel provided to be superposed on the display screen of the display 43, push button switches, and the like. The input signal includes information on the pressing operation to the push button switch, the touch operation to the touch panel and the touched position.

The display 43 performs display on the display screen on the basis of the control by the controller 15. The display contents include the status of the image forming operation, setting menu for receiving the input operation from the user, and the like. As the display screen, for example, the liquid crystal display (LCD), the organic EL (Electro Luminescent) display and the like are used, though not especially limited. The display 43 may have an LED lamp or the like to perform notification of power supply state and/or error state.

Next, the setting operation for image formation in the image forming apparatus 1 in the embodiment will be described.

When the image forming apparatus 1 forms an image, the properties of the formed image such as permeability to the medium of the color material, the degree of fixation, and the degree of expansion (ooze) vary for each type of the medium which is the target to form the image. Accordingly, even in a case where an image based on same image data is formed, it is necessary to change various conditions such as the appropriate amount of color material to be applied, contrast, thickness of line and fixing temperature. In order to form an optimum image based on the image data, preferable settings of image processing and preferable settings of image forming operation are changed for each type of medium M in the image forming apparatus 1.

As the type of medium M, there are plain paper, high-quality paper, coated paper, gloss paper, matte paper, and embossed paper, for example. Though the type of medium M can be narrowed to some degree from these types on the basis of the measurement result by the physical properly measurer 13, it is difficult to completely specify the type of medium M. In the image forming apparatus 1, a predetermined test image is formed by the image forming operator 14 on the medium M for which the physical property was measured, and the test image is read by the reader 20. The type of medium M is then specified on the basis of the reading result of the reader 20 from among the candidates of medium type which were obtained by narrowing the type of medium M on the basis of the measurement result by the physical property measurer 13.

The types of medium M which are the target to be specified by the reading result of the test image include a plurality of combinations of a plurality of medium types (mainly two types) which are assumed to be difficult to distinguish by the physical property measurement in advance. That is, the test image includes a plurality of patterns (test patterns) which enable easily distinguishing each medium type in the combinations of medium types which are difficult to distinguish by the physical property measurement.

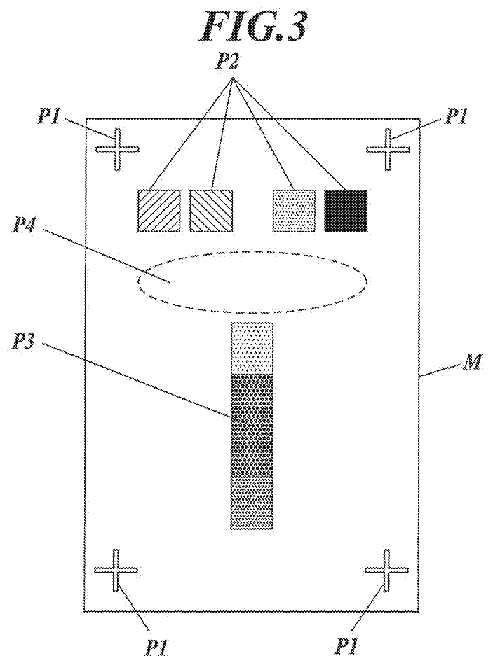

FIG. 3 is a view showing an example of the test image which is used at the time of specifying the medium.

In the test image, cross marks P1 (register marks) are provided at respective four corners in the medium M as a first test pattern. The stretch of the medium M can be specified according to the positional relationship off these cross marks P1.

As the second pattern, solid patches P2 of four colors, for example the four colors of C, M, Y and K are formed. When a color material permeates the medium M, the density of the solid image on the front-side surface is lowered, and the density of the solid image on the back-side surface is raised. That is, these absolute values and ratio of the densities on both sides for the ink of each color reflects the type of the medium M.

The test image also includes a transferring property check pattern P3 as a test pattern. When there is a deviation from an appropriate range of the intensity of the electric field that is applied at the time of transferring a color material to the medium M from the transferring member to which the color material (toner) was applied on the basis of image data, the color material is not normally transferred due to the insufficient attachment of the color material, scattering of the toner caused by electrical discharge, or the like. This transferring property check pattern P3 is obtained by forming halftone images of a predetermined color at a plurality of operation settings (transferring output) while conveying and moving the medium M and changing the operation settings of the transferring output (electric field intensity) continuously or stepwise during the conveyance. By detecting the range in which the transferring was normally performed (desired halftone images were formed) in the transferring property check pattern P3, the type of medium M is limited or specified to the type of medium M according to the range.

Reading may also be performed to a region P4 (colorless pattern as one of the rest patterns) in which color materials are not applied. The brightness value or color value in the region P4, for example, whiteness of the medium M varies according to the presence/absence of coating, the type of finishing of embossing, and the like. According to them, the type of the medium M is limited or specified.

The reading operation of the test image by the first image capturing sensor 22, the second image capturing sensor 23, and the colorimetric sensor 24 may be performed to the entire surface of the medium M. However, the reading operation may not be performed to portions such as margins which do not need to be read in advance.

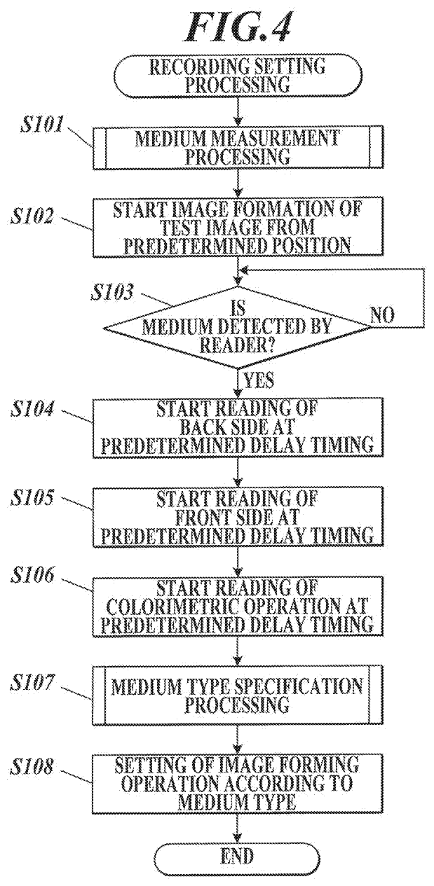

FIG. 4 is a flowchart showing a control procedure by the controller 15 of recording setting processing which is executed in the image forming apparatus 1 in the embodiment.

The recording setting processing is started when the operation receiver 42 receives a recording setting instruction by the user, for example. The recording setting instruction is invoked manually when the medium M is exchanged by the user and newly set in the medium supplier 11.

When the recording setting processing is started, the controller 15 invokes and executes medium measurement processing (step S101). The controller 15 starts to form a test image from a predetermined position of the medium M on the basis of the test image data 172 (step S102).

The controller 15 determines whether the medium M was detected by the medium detector 21 (step S103). If the controller 15 determines that the medium M is not detected (step S103; NO), the controller 15 repeats the processing of step S103.

If the controller 15 determines that the medium M was detected by live medium detector 21 (step S103; YES), the controller 15 starts the leading operation of the back-side surface of the medium M by the first image capturing sensor 22 of the reader 20 after an appropriate delay time according to the conveyance speed passed from the detection timing (at a delay timing) (step S104). The controller 15 starts the reading operation of the front-side surface of the medium M by the second image capturing sensor 23 after an appropriate delay time from the detection timing of the medium M (step S105). The controller 15 starts a colorimetric operation of the front-side surface of the medium M by the colorimetric sensor 24 of the reader 20 after an appropriate delay time from the detection timing of the medium M (step S106).

In the processing of steps S104 to S106, the controller 15 may cause the reader 20 to read only the portion corresponding to each test pattern in the test image so as to be associated with the type of the test pattern, not cause the reader 20 to read the entire medium M.

The controller 15 invokes and executes medium type specification processing (step S107). The controller 15 performs setting of image forming operation according to the specified medium type (step S108). The controller 15 ends recording setting processing.

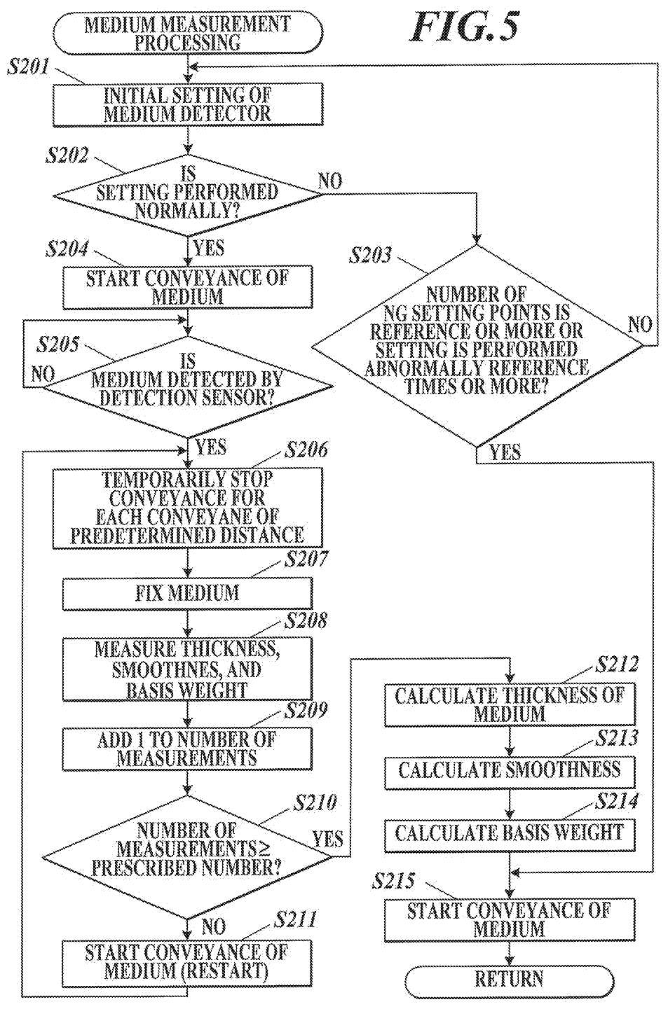

FIG. 5 is a flowchart showing a control procedure by the controller 15 of medium measurement processing invoked in the recording setting processing.

When the medium measurement processing is invoked, the controller 15 performs initial setting of the physical property measurer 13 (step S201). The controller 15 determines whether the initial setting was normally performed (step S202). If the controller 15 determines that the initial setting was not normally performed (step S202; NO), the controller 15 determines whether or not the number of points having the setting NG is a reference or more or the number of times the setting was not performed normally is a reference or more (step S203). If the number of points having the setting NG is not the reference or more and the number of times the setting was not performed normally is not the reference or more (less than the reference) (step S203; NO), the processing of the controller 15 proceeds to step S201.

If the controller 15 determines that the number of points having the setting NG is the reference or more or number of times the initial setting was not performed normally is the reference or more (step S203; YES), the processing of the controller 15 proceeds to step S215. The determination contents in step S203 may be only one of the above two.

In the determination processing of step S202, if it is determined that the initial setting was performed normally (step S202; YES), the controller 15 outputs a control signal to the conveyance driver 16a, and causes the conveyer 16 to start the conveyance operation of the medium M of the setting target from the medium supplier 11 (step S204). The controller 15 determines whether the medium detector 12 detected the medium M (step S205). If the controller 15 determines that the medium detector 12 did not detect the medium M (step S205; NO), the controller 1S repeats the processing of step S205.

If the controller 15 determines that the medium detector 12 detected the medium M (step S205; YES), the controller 15 temporarily stops the conveyance operation at the timing when the medium M was conveyed by a predetermined distance (step S206). The controller 15 presses and fixes predetermined points (for example, five points) in the medium M (step S207). The controller 15 operates the physical property measurer 13 and measures the thickness of medium M, the smoothness of medium M, and the basis weight of medium M on the basis of the measurement results (step S208).

The controller 15 adds 1 to the number of measurements (step S209). The controller 15 determines whether the measurement number is a prescribed number or more (step S210). If the controller 15 determines that the measurement number is not the prescribed number or more (less than the prescribe number) (step S210; NO), the controller 15 causes the conveyance driver 16a to restart the operation of the conveyer 16 (step S211). The processing of the controller 15 then returns to step S206.

If the controller 15 determines that the measurement number is the prescribed number or more (step S210; YES), the controller 15 calculates the thickness of the medium M on the basis of the measurement results of the prescribed number of measurements (step S212). The controller 15 calculates the smoothness of the medium M (step S213), and calculates the basis weight of the medium M (step S214). These calculations may simply obtain an average value of the measurement values of the prescribed number of measurements, or may obtain an average value subtracting the maximum and minimum values of the measurement values. Alternatively, a median value or the like of the measurement values of the prescribed number of measurements may be used as the calculated representative value. The processing of the controller 15 then proceeds to step S215.

When the controller 15 proceeds from the processing of steps S203 and S214 to the processing of step S215, the controller 15 causes the conveyance driver 16a to restart the conveyance operation by the conveyer 16 (step S215). The controller 15 ends the medium measurement processing and returns the processing to the recording setting processing.

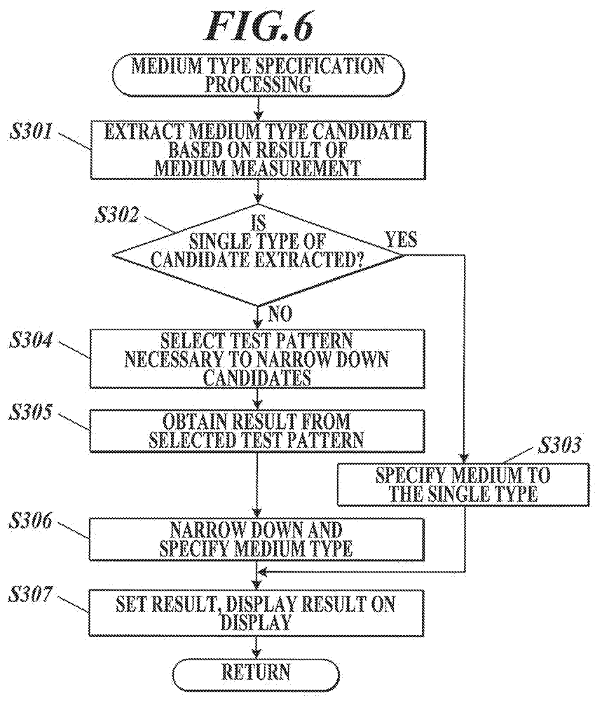

FIG. 6 is a flowchart showing a control procedure by the controller 15 of the medium type specification processing invoked in the recording setting processing.

When the medium type specification processing is invoked, the controller 15 extracts the candidate(s) of the medium type on the basis of the measurement result in the medium measurement processing (step S301). The controller 15 determines whether the extracted candidate(s) is a single type (step S302). If the controller 15 determines that the extracted candidate(s) is a single type (step S302; YES), the controller 15 specifies the medium M to the single medium type (step S303). The processing of the controller 15 proceeds to step S307.

If the controller 15 determines shat the extracted candidate(s) is not a single type (two types or more) (step S302; NO), the controller 15 selects a part of the plurality of test patterns in the test image as the test pattern(s) necessary to narrow down the candidate from the candidates which are two types or more (step S304). The controller 15 obtains the image forming range of the selected test pattern(s) (including the permeating degree of the image into the back side and the space part in the image) in the front-side surface and the back-side surface of the medium M which were read by the reader 20 in the processing of steps S104 to S106, and obtains the reading data in the image forming range (step S305). When the brightness or the chromaticity of the above-mentioned patches or the like is measured, the controller 15 does not need to obtain the reading data of the entire patches, and it is sufficient to obtain the reading data of an appropriate range inside the patches.

The controller 15 analyzes the reading data of the selected part of test patterns) and specifics one optimum type from among the medium types winch are the candidates on the basis of the obtained reading results (the reading results of both sides may be compared as mentioned above) (step S306). The processing of the controller 15 proceeds to step S307.

When the processing proceeds from steps S303 and S306 to step S307, the controller 15 stores the information on the specified medium type in the storage 17, and causes the display 43 to display the specification result (step S307). The controller 15 ends the medium type specification processing, and returns the processing to the recording setting processing.

The reader 20 may be used for detection and adjustment of abnormalities of the image as needed or at appropriate intervals during the image forming operation, not only used for setting of the medium M as mentioned above. The abnormalities of the image here are not limited to the image for which the image quality does not satisfy a predetermined request level, but include the state in which the deviation from an ideal setting image quality becomes larger than a reference level within the range of satisfying the request level. The abnormalities which can be adjusted include density deviation (including density unevenness) and abnormalities of contrast, for example.

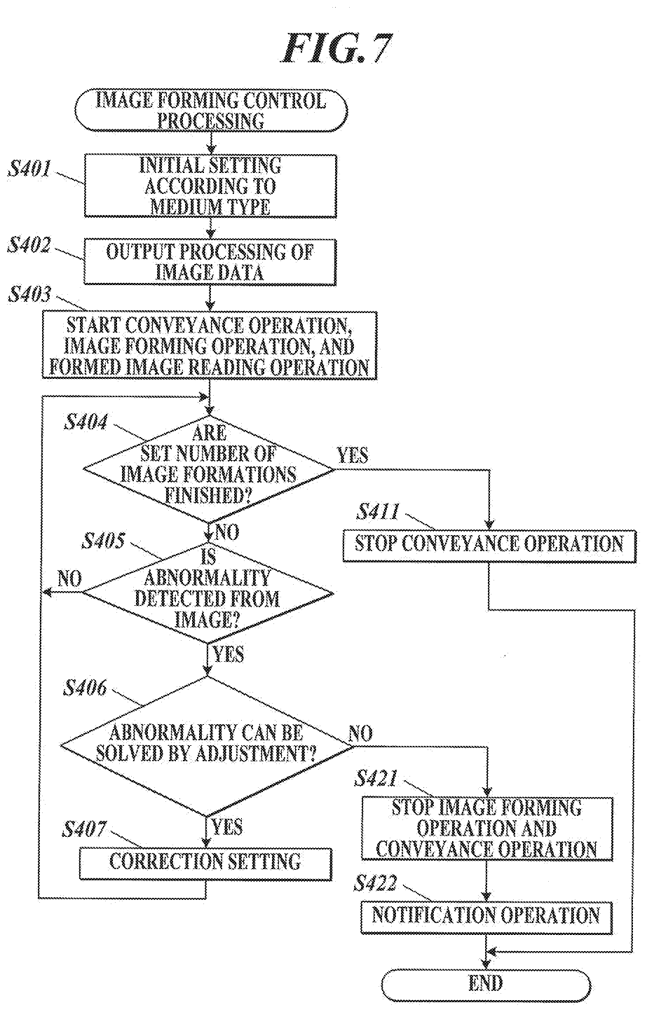

FIG. 7 is a flowchart showing a control procedure by the controller 15 of image forming control processing for normal (usual) image formation which is executed in the image forming apparatus 1. The image forming control processing is started when an instruction of image formation is obtained from an external device via the communicator 41, for example.

When the image forming control processing is obtained, the controller 15 performs initial setting according to the medium type for which the setting is stored in the storage 17 (step S405). The controller 15 performs processing to process the obtained image data (normal image data), which is the target to be formed, into a format adapted to the operation of the image forming operator 14 (step S402).

The controller 15 outputs a control signal to the conveyance driver 16a to start the conveyance of the medium M, outputs a control signal to the image forming operator 14 to start the image forming operation of a normal image (normal image forming operation) on the medium M, and outputs a control signal to the reading driver 25 to start the reading operation of the normal image by each of the sensors of the reader 20 (step S403). The reading operation in this case may be performed by only the second image capturing sensor 23 which reads the front-side surface, for example.

The controller 15 determines whether the set number of image formations were finished (step S404). If the controller 15 determines that the set number of image formations were finished (step S404; YES), the controller 15 ends the conveyance operation by the conveyer 16 (step S411), and ends the image forming control processing.

If the controller 15 determines that the set number of image formations were not finished (step S404; NO), the controller 15 analyzes the reading result by the reader 20, and determines whether any abnormality was detected from the image (step S405). If the controller 15 determines that the abnormality was not detected (step S405; NO), the processing of the controller 15 returns to step S404.

If the controller 15 determines that the abnormality was detected in the image (step S405; YES), the controller 15 determines whether the abnormality can be solved by adjusting the image data or the operation setting of the image forming operator 14 (step S406). If the controller 15 determines that the abnormality can be solved (step S406; YES), the controller 15 performs correction setting (adjustment of setting) of solving the abnormality on the basis of the reading result of the normal image (step S407). The processing of the controller 15 returns to step S404.

If the controller 1S determines that the abnormality cannot be solved (step S406; NO), the controller 15 stops the image forming operation by the image forming operator 14 and the conveyance operation by the conveyer 16 (step S421), and causes the display 43 or the like to perform a predetermined notification operation (step S422). The controller 15 ends the imago forming control processing.

In a case where the abnormality is difficult to detect from the image which is the target to be formed, a predetermined test pattern image for detecting the abnormality may be formed for each predetermined number of sheets. In this case, it is sufficient that the controller 15 causes the reader 20 to read only this test pattern image. In a case where a plurality of ejection trays 31 are provided and the destination to eject the sheet can be switched between the ejection trays 31, the medium M on which the test pattern image was formed may be ejected separately from the medium M on which the normal image was formed.

As described above, the image forming apparatus 1 in the embodiment includes a physical property measurer 13 which measures the physical property of a medium M on which an image is formed, an image forming operator 14 which forms the image on the medium M, a reader 20 which reads the formed image, and a controller 15 as a medium specifier which specifics the medium type on the basis of the measurement result by the physical property measurer 13 and the reading result by the reader 20.

In such a way, even in a case where the sensor is a simple physical property measurement sensor and the type of the medium M cannot be completely specified by only the measured physical property, the medium type is determined on the basis of the image which was recorded on the medium M, together with the measured physical property. Thus, it is possible to accurately specify the medium type easily and efficiently by the combination of them.

The controller 15 of the image forming apparatus 1 causes the image forming operator 14 to form a predetermined test image as an operation controller, and specifies the medium type by using the reading result of this test image as a medium specifier.

The combinations of medium types which cannot be easily distinguished by measuring physical properties axe generally determined in advance. Thus, by preparing a test image including patterns which enables easily distinguishing such combinations, and causing the test image to be formed, it is possible to specify the medium type easily and surely by a single image formation. Accordingly, the image forming apparatus 1 enables reducing time and trouble necessary for specifying the medium type and suppressing the consumption of medium M and ink.

The test image includes a plurality of patterns, and the controller 15 as a medium specifier specifies the medium type by using the reading result of a part of the plurality of patterns selected according to the candidates of medium type extracted by using the measurement result by the physical property measurer 13.

The pattern of test image necessary to specify the medium type among combinations of medium types which cannot be easily specified by measuring the physical property is already known. Thus, by selectively analyzing only this necessary pattern and specifying the medium type in the image forming apparatus 1, it Is possible to eliminate unnecessary analysis processing and more reduce the time and trouble of processing.

The controller 15 as an operation controller causes the image forming operator 14 to form a part of the plurality of patterns by a plurality of operation settings while changing the operation setting of image formation during forming of the part of the plurality of patterns, the operation setting being, for example, a transfer voltage in the embodiment.

By such a way, in the image forming apparatus 1, it is possible to more surely specify the medium type which cannot be easily distinguished by simple measurement of physical property, by not only forming the test image at a fixed setting but also forming the test image while changing the operation setting of image formation.

The reader 20 can read both sides of the medium M, and the controller 15 as a medium specifier can specify the medium type on the basis of the reading results of both sides.

In the image forming apparatus 1, it is possible to more surely specify the medium M by obtaining not only the transmission of light, thickness of medium or the like obtained as physical property measurement but also the information regarding how much degree the color material actually permeates and penetrates the medium M.

The controller 15 as the operation controller adjusts the setting of image forming operation on the basis of the reading result by the reader 20 of the normal image which was formed by the normal image forming operation. That is, in the image forming apparatus 1, the reader 20 can be used for not only specifying the type of medium M but also detecting abnormalities real time or at predetermined intervals at the normal image formation. Thus, in the image forming apparatus 1, it is possible to improve the operation rate of reader 20 and perform image formation at an appropriate image quality more efficiently and stably.

The reader 20 may read the colorless pattern in the image formed on the medium M. By reading the colorless portion with the second image capturing sensor 23, the colorimetric sensor 24 and the like, it is possible to measure the whiteness or the like of the medium M. There is a case where the type of medium M can be specified even by such reading, and it is possible to more surely specify the type of medium M and form an appropriate image at the operation setting according to the medium M without increasing the configuration and trouble for the test in the image forming apparatus 1.

The present invention is not limited to the above embodiment, and various modifications can be made.

For example, in the embodiment, the test image determined in test image data 172 is formed in advance and the reading result is used. However, the test image may not be formed in a case where the medium M can be specified by the reading result of the normal image while the normal image is formed.

In the embodiment, the whiteness of the medium M is obtained on the basis of the reading result of the reader 20. However, the physical property of the medium M may be obtained by the reader 20 after image forming operation as for the physical property which does not provide bad influence to the specification of medium M such as the physical property for which the measurement result is not changed by the image forming operation (mainly, fixing operation) and the physical property for which the change degree can be assumed. Alternatively, the whiteness may be obtained before the image forming operation by the physical property measurer 13 or the measurement may be performed twice before and after the image forming operation as for the property regarding the change of measurement result by the fixing operation, which is useful for specifying the medium M.

The reader 20 performs image capturing of the formed image with visible light and performs colorimetry in the embodiment. However, other reading operations may be performed. For example, though the reflection state of light on the surface of the medium M is measured with the physical property measurer 13 in the embodiment, the reflection state of light on the surface of the color material which was fixed on the medium M may be measured. Though reading is performed to the image after the fixing operation of the color material was performed in the embodiment, the reading result of the image before the fixing operation may be used instead of/ in addition to the reading result of the image after the fixing operation.

The patterns of the test image shown in FIG. 3 are illustrated examples. The patterns do not need to include all of these patterns and may include patterns other than these patterns.

Though the image capturing sensor which reads the front-side surface of the medium M and the image capturing sensor which reads the back-side surface are separately provided in the embodiment, both sides may be read with a single image capturing sensor by reversing the medium M.

The reader 20 may he configured to be attachable and detachable with respect to the recorder 10 or may be arranged to be completely integrated with the recorder 10. Similarly, the physical property measurer 13 may be configured to be attachable to the recorder 10 as a unit, or may be provided in the recorder 10 to be completely integrated with the image forming operator 14 or the like.

The reader 20 is described that the second image capturing sensor 23 may be used for monitoring the image quality during the normal image formation in the embodiment. However, the second image capturing sensor 23 may not be used for monitoring image quality, and either or both of the sensors may be used for other usage.

Though the embodiment is described by taking, as an example, an electrophotographic image forming apparatus, the image forming apparatus may be other types of image forming apparatuses such as an inkjet recording apparatus which forms an image by ejecting ink and making the ink land on the medium.

As for the other specific details such as the configurations, structures, processing contents, and processing procedures shown in the embodiment, modifications can be made as needed within the scope of the present invention. Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-131285, filed on Jul. 11, 2018, including description, claims, drawings and abstract is incorporated herein by reference in its entirety.

What is claimed is:

1. An image forming apparatus comprising:
a measurer which measures a physical properly of a medium on which an image is formed;
an image forming operator which forms the image on the medium;
a reader which reads the formed image; and
a hardware processor which specifies a medium type based on a measurement result by the measurer and a reading result by the reader.

2. The image forming apparatus according to claim 1, wherein the hardware processor causes the image forming operator to form a predetermined test image, and specifies the medium type by using the reading result of the predetermined test image.

3. The image forming apparatus according to claim 2, wherein
the test image includes a plurality of patterns, and
the hardware processor specifies the medium type by using the reading result of a part of the plurality of patterns selected according to a candidate of the medium type which is extracted by using the measurement result by the measurer.

4. The image forming apparatus according to claim 2, wherein
the test image includes a plurality of patterns, and
the hardware processor causes the image forming operator to form a part of the plurality of patterns by a plurality of operation settings while changing an operation setting of image formation during forming of the part of the plurality of patterns.

5. The image forming apparatus according to claim 3, wherein the plurality of patterns include a colorless pattern.

6. The image forming apparatus according to claim 1, wherein
the reader is able to read both sides of the medium, and
the hardware processor specifies the medium type based on the reading result of the both sides.

7. The image forming apparatus according to claim 2, wherein the hardware processor adjusts a setting of an image forming operation based on the reading result by the reader of a normal image which is formed by a normal image forming operation.
